(19) United States
(12) Patent Application Publication
(10) Pub. No.: US 2016/0179611 A1
(43) Pub. Date: Jun. 23, 2016

(54) LOW OVERHEAD ERROR CHECKING AND CORRECTION APPARATUS AND METHOD

(71) Applicants: Thuyen Le, Taufkirchen (DE); Kay Hesse, Dresden (DE); Uwe Steeb, Dresden (DE); Tian Yan Pu, Dresden (DE); Lars Melzer, Dresden (DE)

(72) Inventors: Thuyen Le, Taufkirchen (DE); Kay Hesse, Dresden (DE); Uwe Steeb, Dresden (DE); Tian Yan Pu, Dresden (DE); Lars Melzer, Dresden (DE)

(21) Appl. No.: 14/581,878

(22) Filed: Dec. 23, 2014

(51) Int. Cl. G06F 11/10

(52) U.S. Cl. CPC G06F 11/10

(57) ABSTRACT

An apparatus and method are described for performing a low overhead error checking and correction. For example, one embodiment of an electronic circuit comprises: one or more memories to store data or instructions in rows and columns, and to further store row parity data comprising a parity value associated with each row and column parity data comprising a parity value associated with each column; and error checking logic to perform a row parity check to detect if errors exist in any of the rows, wherein if an error is detected in one of the rows, the error checking and correction logic is to perform a column parity check to identify a column in which the detected error occurred; and error correction logic to correct the detected error using the detected row and column identified by the error checking logic.

### BACKGROUND

1. Field of the Invention

This invention relates generally to the field of computer processors. More particularly, the invention relates to a method and apparatus for reverse memory sparing.

2. Description of the Related Art

Trapping and de-trapping of charges causes significant Vcc_min fluctuation in static on-chip memories such as static random access memories (SRAMs). By definition, if Vcc_min becomes larger than the supply voltage, and if the bit is accessed (either read or written), the bit can be flipped. This error event varies temporally and spatially and the erratic bit error is a “soft” error (i.e., the cell becomes normal again after some random time).

In a SoC (System-on-Chip) with different on-chip memories, every on-chip memory is classified based on the extent to which an erratic bit impacts the functionality of the overall system. As an example, “class 1” may refer to memories which are highly sensitive such that one erratic bit would lead to a total crash or malfunction. An example for this class are all instruction memories of all controller cores (micro-controller, digital signal processors, etc). Some parts of the data memory of those controller cores can be also classified as class 1. “Class 2” may refer to parameter memories dedicated to a hardware accelerator or part of the controller data memory. In this case, an erratic bit will always lead to a malfunction and/or major KPI (key performance indicator) impact but not necessarily to a total crash.

Other classes are defined according to the impact of the erratic bit to the overall system and visibility to the customer. The last memory class refers to memories for which an erratic bit is invisible; example of this class is a memory storing data samples received over the air interface. Depending on the memory classification, special circuitry and memory overhead have been introduced to support error checking and correction (ECC).

### BRIEF DESCRIPTION OF THE DRAWINGS

A better understanding of the present invention can be obtained from the following detailed description in conjunction with the following drawings, in which:

FIG. 1A is a block diagram illustrating both an exemplary in-order fetch, decode, retire pipeline and an exemplary register renaming, out-of-order issue/execution pipeline according to embodiments of the invention;

FIG. 1B is a block diagram illustrating both an exemplary embodiment of an in-order fetch, decode, retire core and an exemplary register renaming, out-of-order issue/execution architecture core to be included in a processor according to embodiments of the invention;

FIG. 2 is a block diagram of a single core processor and a multicore processor with integrated memory controller and graphics according to embodiments of the invention;

FIG. 3 illustrates a block diagram of a system in accordance with one embodiment of the present invention;

FIG. 4 illustrates a block diagram of a second system in accordance with an embodiment of the present invention;

FIG. 5 illustrates a block diagram of a third system in accordance with an embodiment of the present invention;

FIG. 6 illustrates a block diagram of a system on a chip (SoC) in accordance with an embodiment of the present invention;

FIG. 7 illustrates a block diagram contrasting the use of a software instruction converter to convert binary instructions in a source instruction set to binary instructions in a target instruction set according to embodiments of the invention;

FIG. 8 illustrates one embodiment of a processor architecture on which the embodiments of the invention may be implemented;

FIG. 9 illustrates one embodiment of the invention which stores both column parity data and row parity data for a memory;

FIG. 10 illustrates additional details of one embodiment which includes logic for checking row parity and column parity;

FIG. 11 illustrates the benefits of one embodiment of the invention over existing techniques; and

FIG. 12 illustrates a method in accordance with one embodiment of the invention.

### DETAILED DESCRIPTION

In the following description, for the purposes of explanation, numerous specific details are set forth in order to provide a thorough understanding of the embodiments of the invention described below. It will be apparent, however, to one skilled in the art that the embodiments of the invention may be practiced without some of these specific details. In other instances, well-known structures and devices are shown in block diagram form to avoid obscuring the underlying principles of the embodiments of the invention.

### Exemplary Processor Architectures and Data Types

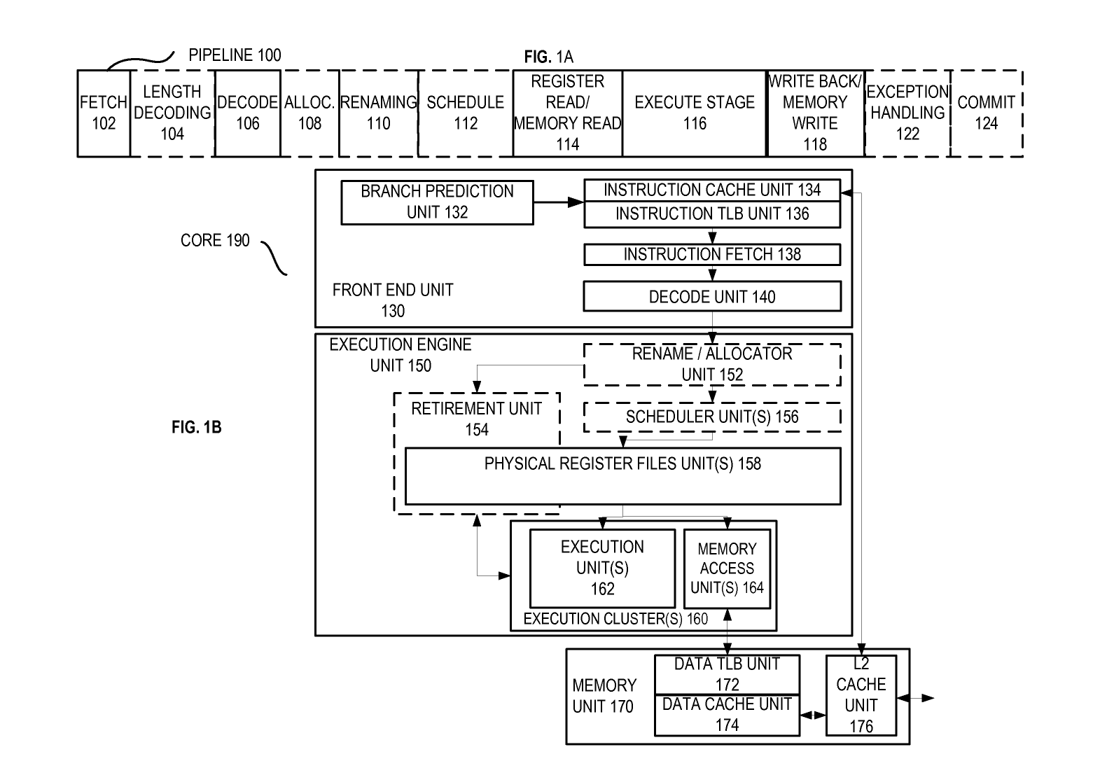

FIG. 1A is a block diagram illustrating both an exemplary in-order fetch, decode, retire pipeline and an exemplary register renaming, out-of-order issue/execution pipeline according to embodiments of the invention. FIG. 1B is a block diagram illustrating both an exemplary embodiment of an in-order fetch, decode, retire core and an exemplary register renaming, out-of-order issue/execution architecture core to be included in a processor according to embodiments of the invention. The solid lined boxes in FIGS. 1A-B illustrate the in-order portions of the pipeline and core, while the optional addition of the dashed lined boxes illustrates the register renaming, out-of-order issue/execution pipeline and core.

In FIG. 1A, a processor pipeline 100 includes a fetch stage 102, a length decode stage 104, a decode stage 106, an allocation stage 108, a renaming stage 110, a scheduling (also known as a dispatch or issue) stage 112, a register read/memory read stage 114, an execute stage 116, a write back/memory write stage 118, an exception handling stage 122, and a commit stage 124.

FIG. 1B shows processor core 190 including a front end unit 130 coupled to an execution engine unit 150, and both are coupled to a memory unit 170. The core 190 may be a reduced instruction set computing (RISC) core, a complex instruction set computing (CISC) core, a very long instruction word (VLIW) core, or a hybrid or alternative core type. As yet another option, the core 190 may be a special-purpose core, such as, for example, a network or communication core, compression engine, coprocessor core, general purpose computing graphics processing unit (GPGPU) core, graphics core, or the like.

The front end unit 130 includes a branch prediction unit 132 coupled to an instruction cache unit 134, which is coupled to an instruction translation lookaside buffer (TLB) 136, which is coupled to an instruction fetch unit 138, which is coupled to a decode unit 140. The decode unit 140 (or decoder) may decode instructions, and generate as an output one or more micro-operations, micro-code entry points, microinstructions, other instructions, or other control signals, which are decoded from, or which otherwise reflect, or are derived from, the original instructions. The decode unit 140 may be implemented using various different mechanisms. Examples of suitable mechanisms include, but are not limited to, look-up tables, hardware implementations, programmable logic arrays (PLAs), microcode read only memories (ROMs), etc. In one embodiment, the core 190 includes a microcode ROM or other medium that stores microcode for certain macroinstructions (e.g., in decode unit 140 or otherwise within the front end unit 130). The decode unit 140 is coupled to a rename/allocator unit 152 in the execution engine unit 150.

The execution engine unit 150 includes the rename/allocator unit 152 coupled to a retirement unit 154 and a set of one or more scheduler unit(s) 156. The scheduler unit(s) 156 represents any number of different schedulers, including reservations stations, central instruction window, etc. The scheduler unit(s) 156 is coupled to the physical register file(s) unit(s) 158. Each of the physical register file(s) units 158 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 158 comprises a vector registers unit, a write mask registers unit, and a scalar registers unit. These register units may provide architectural vector registers, vector mask registers, and general purpose registers. The physical register file(s) unit(s) 158 is overlapped by the retirement unit 154 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 154 and the physical register file(s) unit(s) 158 are coupled to the execution cluster(s) 160. The execution cluster(s) 160 includes a set of one or more execution units 162 and a set of one or more memory access units 164. The execution units 162 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 156, physical register file(s) unit(s) 158, and execution cluster(s) 160 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 164). It should also be understood that where separate pipelines are used, one or more of these pipelines may be out-of-order issue/execution and the rest in-order.

The set of memory access units 164 is coupled to the memory unit 170, which includes a data TLB unit 172 coupled to a data cache unit 174 coupled to a level 2 (L2) cache unit 176. In one exemplary embodiment, the memory access units 164 may include a load unit, a store address unit, and a store data unit, each of which is coupled to the data TLB unit 172 in the memory unit 170. The instruction cache unit 134 is further coupled to a level 2 (L2) cache unit 176 in the memory unit 170. The L2 cache unit 176 is coupled to one or more other levels of cache and eventually to a main memory.

By way of example, the exemplary register renaming, out-of-order issue/execution core architecture may implement the pipeline 100 as follows: 1) the instruction fetch 138 performs the fetch and length decoding stages 102 and 104; 2) the decode unit 140 performs the decode stage 106; 3) the rename/allocator unit 152 performs the allocation stage 108 and renaming stage 110; 4) the scheduler unit(s) 156 performs the schedule stage 112; 5) the physical register file(s) unit(s) 158 and the memory unit 170 perform the register read/memory read stage 114; the execution cluster 160 perform the execute stage 116; 6) the memory unit 170 and the physical register file(s) unit(s) 158 perform the write back/memory write stage 118; 7) various units may be involved in the exception handling stage 122; and 8) the retirement unit 154 and the physical register file(s) unit(s) 158 perform the commit stage 124.

The core 190 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 190 includes logic to support a packed data instruction set extension (e.g., AVX1, AVX2, and/or some form of the generic vector friendly instruction format (U=0 and/or U=1), described below), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 134/174 and a shared L2 cache unit 176, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

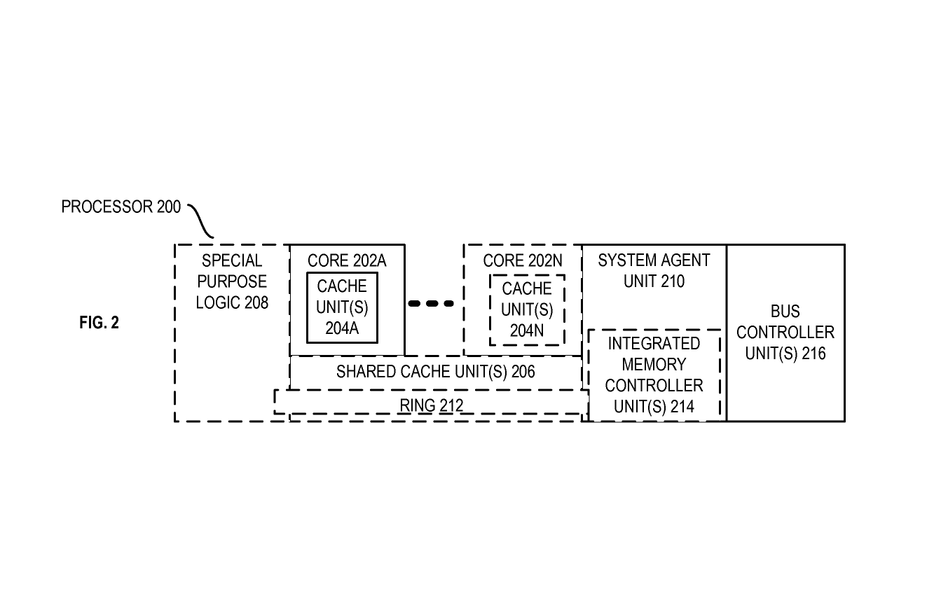

FIG. 2 is a block diagram of a processor 200 that may have more than one core, may have an integrated memory controller, and may have integrated graphics according to embodiments of the invention. The solid lined boxes in FIG. 2 illustrate a processor 200 with a single core 202A, a system agent 210, a set of one or more bus controller units 216, while the optional addition of the dashed lined boxes illustrates an alternative processor 200 with multiple cores 202A-N, a set of one or more integrated memory controller unit(s) 214 in the system agent unit 210, and special purpose logic 208.

Thus, different implementations of the processor 200 may include: 1) a CPU with the special purpose logic 208 being integrated graphics and/or scientific (throughput) logic (which may include one or more cores), and the cores 202A-N being one or more general purpose cores (e.g., general purpose in-order cores, general purpose out-of-order cores, a combination of the two); 2) a coprocessor with the cores 202A-N being a large number of special purpose cores intended primarily for graphics and/or scientific (throughput); and 3) a coprocessor with the cores 202A-N being a large number of general purpose in-order cores. Thus, the processor 200 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 200 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 206, and external memory (not shown) coupled to the set of integrated memory controller units 214. The set of shared cache units 206 may include one or more mid-level caches, such as level 2 (L2), level 3 (L3), level 4 (L4), or other levels of cache, a last level cache (LLC), and/or combinations thereof. While in one embodiment a ring based interconnect unit 212 interconnects the integrated graphics logic 208, the set of shared cache units 206, and the system agent unit 210/integrated memory controller unit(s) 214, alternative embodiments may use any number of well-known techniques for interconnecting such units. In one embodiment, coherency is maintained between one or more cache units 206 and cores 202-A-N.

In some embodiments, one or more of the cores 202A-N are capable of multi-threading. The system agent 210 includes those components coordinating and operating cores 202A-N. The system agent unit 210 may include for example a power control unit (PCU) and a display unit. The PCU may be or include logic and components needed for regulating the power state of the cores 202A-N and the integrated graphics logic 208. The display unit is for driving one or more externally connected displays.

The cores 202A-N may be homogenous or heterogeneous in terms of architecture instruction set; that is, two or more of the cores 202A-N may be capable of execution the same instruction set, while others may be capable of executing only a subset of that instruction set or a different instruction set. In one embodiment, the cores 202A-N are heterogeneous and include both the “small” cores and “big” cores described below.

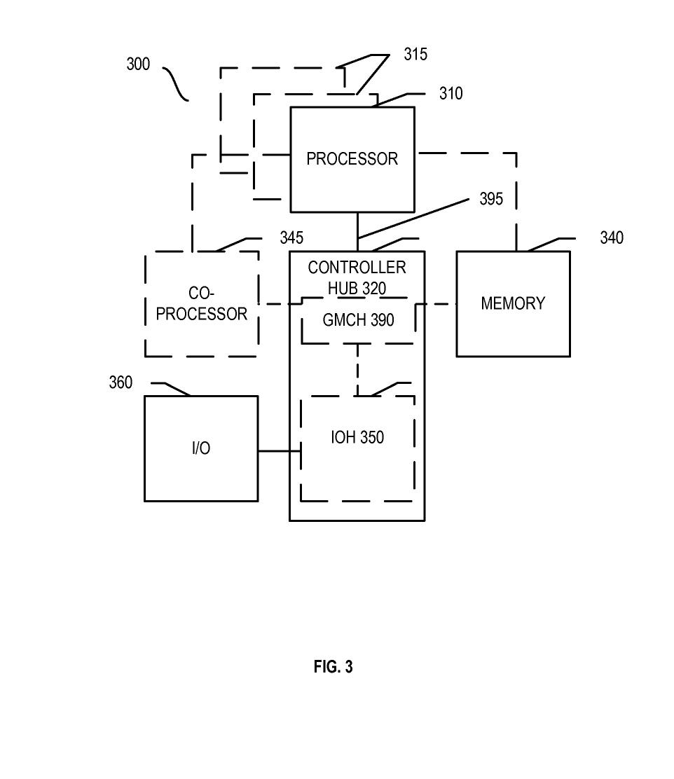

FIGS. 3-6 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 3, shown is a block diagram of a system 300 in accordance with one embodiment of the present invention. The system 300 may include one or more processors 310, 315, which are coupled to a controller hub 320. In one embodiment the controller hub 320 includes a graphics memory controller hub (GMCH) 390 and an Input/Output Hub (IOH) 350 (which may be on separate chips); the GMCH 390 includes memory and graphics controllers to which are coupled memory 340 and a coprocessor 345; the IOH 350 is couples input/output (I/O) devices 360 to the GMCH 390. Alternatively, one or both of the memory and graphics controllers are integrated within the processor (as described herein), the memory 340 and the coprocessor 345 are coupled directly to the processor 310, and the controller hub 320 in a single chip with the IOH 350.

The optional nature of additional processors 315 is denoted in FIG. 3 with broken lines. Each processor 310, 315 may include one or more of the processing cores described herein and may be some version of the processor 200.

The memory 340 may be, for example, dynamic random access memory (DRAM), phase change memory (PCM), or a combination of the two. For at least one embodiment, the controller hub 320 communicates with the processor(s) 310, 315 via a multi-drop bus, such as a frontside bus (FSB), point-to-point interface such as QuickPath Interconnect (QPI), or similar connection 395.

In one embodiment, the coprocessor 345 is a special-purpose processor, such as, for example, a high-throughput MIC processor, a network or communication processor, compression engine, graphics processor, GPGPU, embedded processor, or the like. In one embodiment, controller hub 320 may include an integrated graphics accelerator.

There can be a variety of differences between the physical resources 310, 315 in terms of a spectrum of metrics of merit including architectural, microarchitectural, thermal, power consumption characteristics, and the like.

In one embodiment, the processor 310 executes instructions that control data processing operations of a general type. Embedded within the instructions may be coprocessor instructions. The processor 310 recognizes these coprocessor instructions as being of a type that should be executed by the attached coprocessor 345. Accordingly, the processor 310 issues these coprocessor instructions (or control signals representing coprocessor instructions) on a coprocessor bus or other interconnect, to coprocessor 345. Coprocessor(s) 345 accept and execute the received coprocessor instructions.

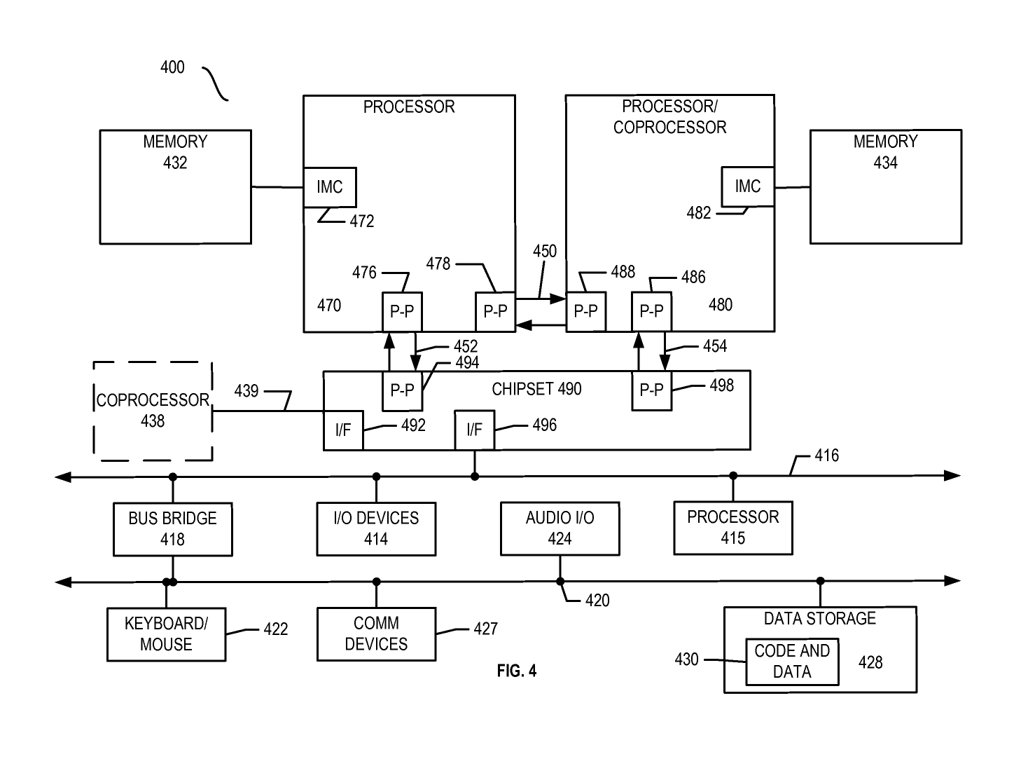

Referring now to FIG. 4, shown is a block diagram of a first more specific exemplary system 400 in accordance with an embodiment of the present invention. As shown in FIG. 4, multiprocessor system 400 is a point-to-point interconnect system, and includes a first processor 470 and a second processor 480 coupled via a point-to-point interconnect 450. Each of processors 470 and 480 may be some version of the processor 200. In one embodiment of the invention, processors 470 and 480 are respectively processors 310 and 315, while coprocessor 438 is coprocessor 345. In another embodiment, processors 470 and 480 are respectively processor 310 coprocessor 345.

Processors 470 and 480 are shown including integrated memory controller (IMC) units 472 and 482, respectively. Processor 470 also includes as part of its bus controller units point-to-point (P-P) interfaces 476 and 478; similarly, second processor 480 includes P-P interfaces 486 and 488. Processors 470, 480 may exchange information via a point-to-point (P-P) interface 450 using P-P interface circuits 478, 488. As shown in FIG. 4, IMCs 472 and 482 couple the processors to respective memories, namely a memory 432 and a memory 434, which may be portions of main memory locally attached to the respective processors.

Processors 470, 480 may each exchange information with a chipset 490 via individual P-P interfaces 452, 454 using point to point interface circuits 476, 494, 486, 498. Chipset 490 may optionally exchange information with the coprocessor 438 via a high-performance interface 439. In one embodiment, the coprocessor 438 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 490 may be coupled to a first bus 416 via an interface 496. In one embodiment, first bus 416 may be a Peripheral Component Interconnect (PCI) bus, or a bus such as a PCI Express bus or another third generation I/O interconnect bus, although the scope of the present invention is not so limited.

As shown in FIG. 4, various I/O devices 414 may be coupled to first bus 416, along with a bus bridge 418 which couples first bus 416 to a second bus 420. In one embodiment, one or more additional processor(s) 415, such as coprocessors, high-throughput MIC processors, GPGPU's, accelerators (such as, e.g., graphics accelerators or digital signal processing (DSP) units), field programmable gate arrays, or any other processor, are coupled to first bus 416. In one embodiment, second bus 420 may be a low pin count (LPC) bus. Various devices may be coupled to a second bus 420 including, for example, a keyboard and/or mouse 422, communication devices 427 and a storage unit 428 such as a disk drive or other mass storage device which may include instructions/code and data 430, in one embodiment. Further, an audio I/O 424 may be coupled to the second bus 420. Note that other architectures are possible. For example, instead of the point-to-point architecture of FIG. 4, a system may implement a multi-drop bus or other such architecture.

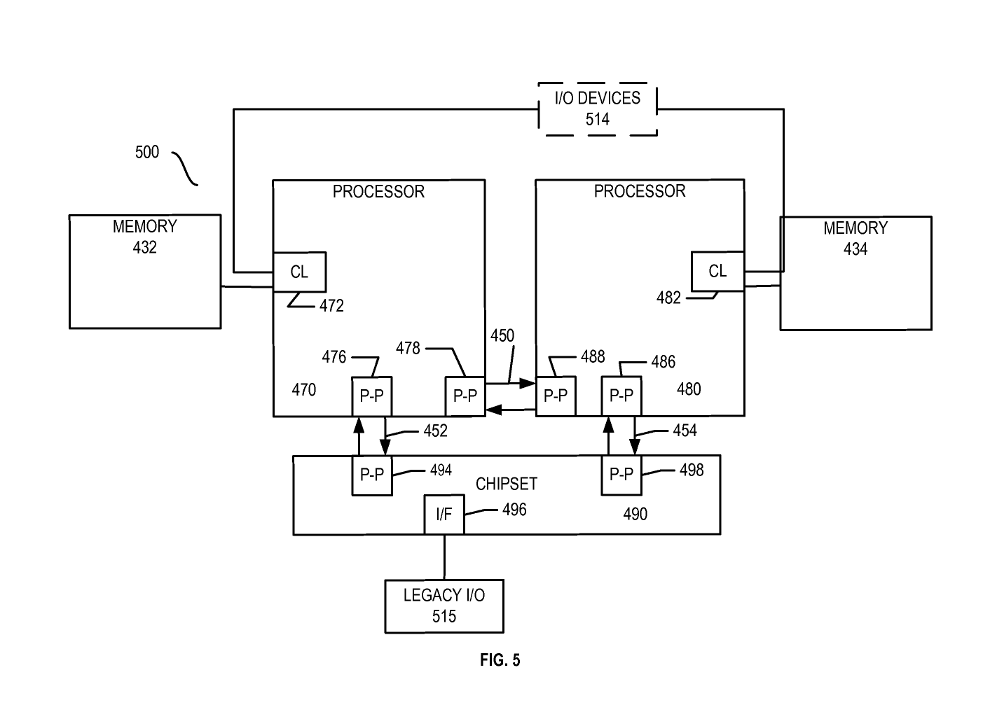

Referring now to FIG. 5, shown is a block diagram of a second more specific exemplary system 500 in accordance with an embodiment of the present invention. Like elements in FIGS. 4 and 5 bear like reference numerals, and certain aspects of FIG. 4 have been omitted from FIG. 5 in order to avoid obscuring other aspects of FIG. 5.

FIG. 5 illustrates that the processors 470, 480 may include integrated memory and I/O control logic (“CL”) 472 and 482, respectively. Thus, the CL 472, 482 include integrated memory controller units and include I/O control logic. FIG. 5 illustrates that not only are the memories 432, 434 coupled to the CL 472, 482, but also that I/O devices 514 are also coupled to the control logic 472, 482. Legacy I/O devices 515 are coupled to the chipset 490.

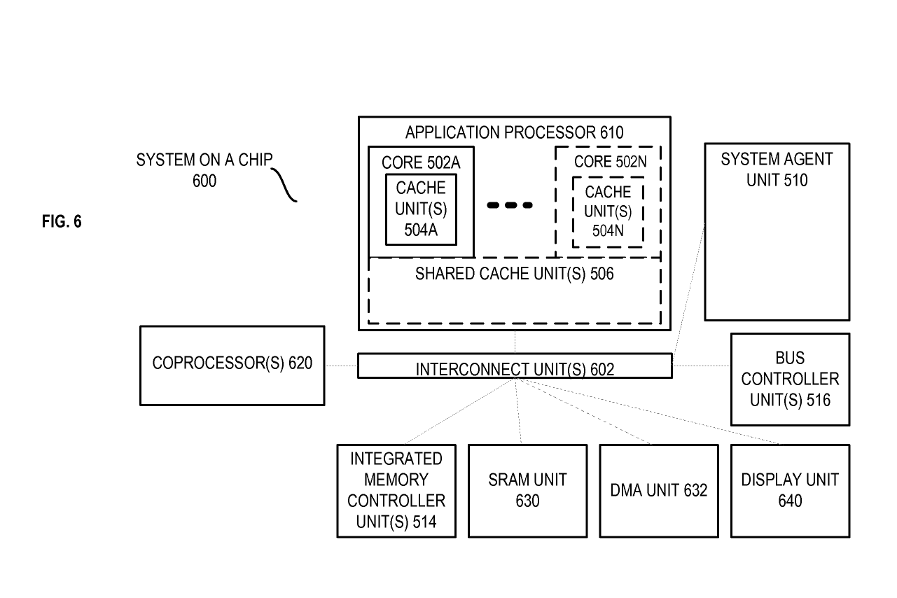

Referring now to FIG. 6, shown is a block diagram of a SoC 600 in accordance with an embodiment of the present invention. Similar elements in FIG. 2 bear like reference numerals. Also, dashed lined boxes are optional features on more advanced SoCs. In FIG. 6, an interconnect unit(s) 602 is coupled to: an application processor 610 which includes a set of one or more cores 202A-N and shared cache unit(s) 206; a system agent unit 210; a bus controller unit(s) 216; an integrated memory controller unit(s) 214; a set or one or more coprocessors 620 which may include integrated graphics logic, an image processor, an audio processor, and a video processor; an static random access memory (SRAM) unit 630; a direct memory access (DMA) unit 632; and a display unit 640 for coupling to one or more external displays. In one embodiment, the coprocessor(s) 620 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 430 illustrated in FIG. 4, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

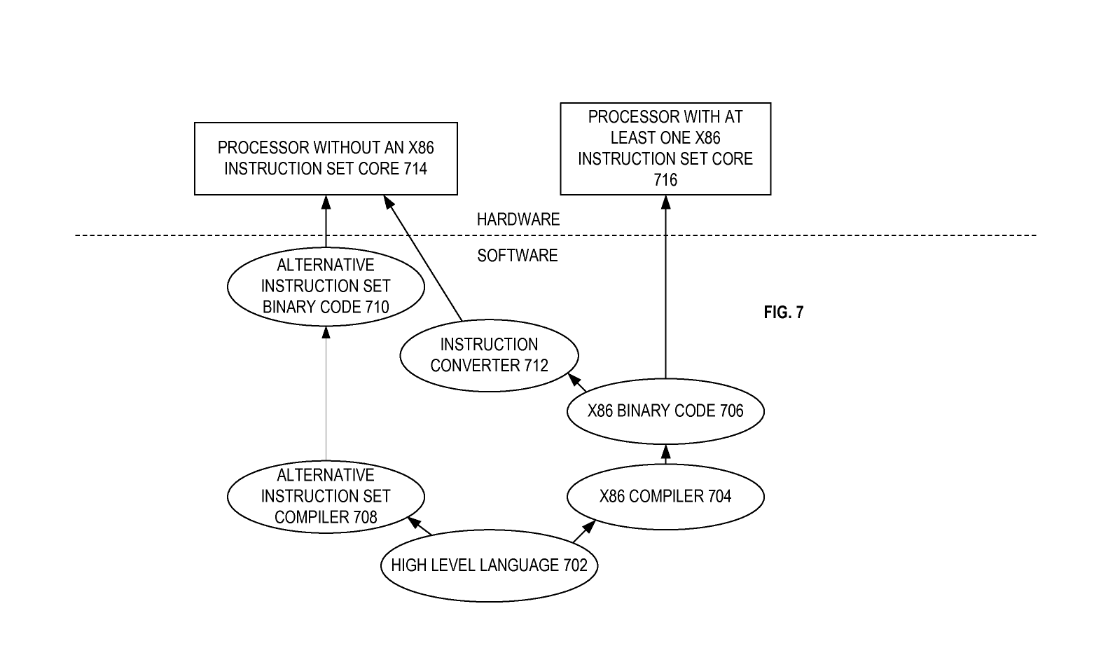

FIG. 7 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 7 shows a program in a high level language 702 may be compiled using an x86 compiler 704 to generate x86 binary code 706 that may be natively executed by a processor with at least one x86 instruction set core 716. The processor with at least one x86 instruction set core 716 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 704 represents a compiler that is operable to generate x86 binary code 706 (e.g., object code) that can, with or without additional linkage processing, be executed on the processor with at least one x86 instruction set core 716. Similarly, FIG. 7 shows the program in the high level language 702 may be compiled using an alternative instruction set compiler 708 to generate alternative instruction set binary code 710 that may be natively executed by a processor without at least one x86 instruction set core 714 (e.g., a processor with cores that execute the MIPS instruction set of MIPS Technologies of Sunnyvale, Calif. and/or that execute the ARM instruction set of ARM Holdings of Sunnyvale, Calif.). The instruction converter 712 is used to convert the x86 binary code 706 into code that may be natively executed by the processor without an x86 instruction set core 714. This converted code is not likely to be the same as the alternative instruction set binary code 710 because an instruction converter capable of this is difficult to make; however, the converted code will accomplish the general operation and be made up of instructions from the alternative instruction set. Thus, the instruction converter 712 represents software, firmware, hardware, or a combination thereof that, through emulation, simulation or any other process, allows a processor or other electronic device that does not have an x86 instruction set processor or core to execute the x86 binary code 706.

### Low Overhead Error Checking and Correction Apparatus and Method

The embodiments of the invention described herein may be used for memories in which an erratic bit will impact the functionality of the overall system. By way of example, one embodiment focuses on an error checking and correction (ECC) solution for class 1 memories, for which ECC is by definition mandatory (e.g., such as controller instruction memories which will be only read and not written in normal operation). It should be noted, however, that the underlying principles of the invention may be used wherever a short stall to correct an error is acceptable (i.e. no on-the-fly correction is required).

A well known way to implement ECC is to include a Hamming code with each instruction word. For a 32-bit instruction, 6 parity bits are used, leading to a total of 38-bits, or an 18.75% overhead for correcting single-bit errors. These ECC techniques may be fully transparent to software as the hardware circuitry is simple enough to detect and correct a single bit error. The drawback is the high overhead of 18.75%.

Extending the Hamming code to a larger data block will reduce the overhead but the circuitry then becomes too complex for on-the-fly detection and correction. This type of circuitry could be used, however, to detect and correct the memory content for a transition from retention to active mode.

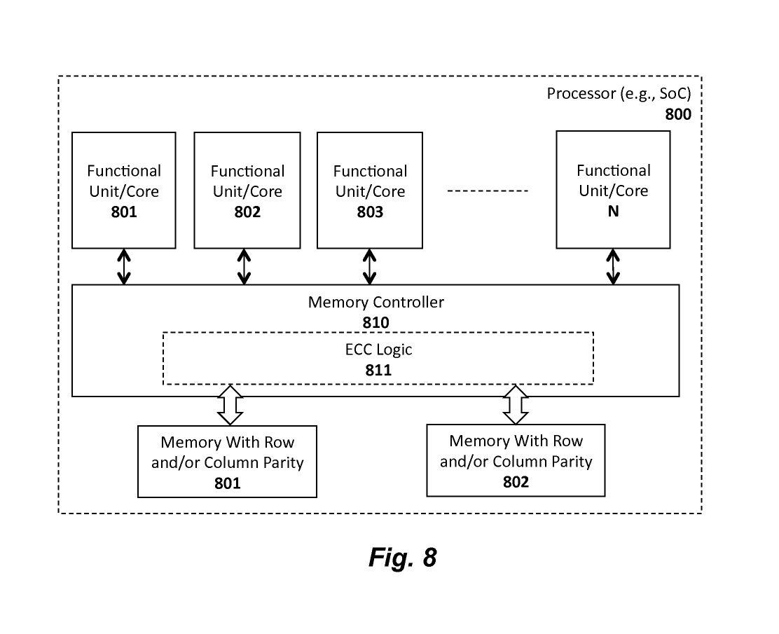

As illustrated in FIG. 8, the embodiments of the invention may be implemented on a processor 800 (e.g., a SoC) with a plurality of functional units/cores 801-803, N. Each of the functional units/cores 801-803, N are communicatively coupled to one or more on-chip memories 801-802 through a memory controller 810. As mentioned above, the memories 801-802 may be controller instruction memories. However, the underlying principles of the invention are not limited to any particular type of memory. In one embodiment, each memory 801-802 stores both row and column parity data used for implementing the techniques described below. In addition, the illustrated memory controller 810 includes ECC logic 811 for implementing the error checking and correction techniques described below using the row and column parity data.

While this particular architecture is shown for the purpose of illustration, it should be noted that the underlying principles of the invention are not limited to any particular system architecture. For example, the ECC logic 811 may be integrated directly within the memory devices 801-802 and the row/column parity data may be stored in memory devices separate from the memory in which the underlying data is stored.

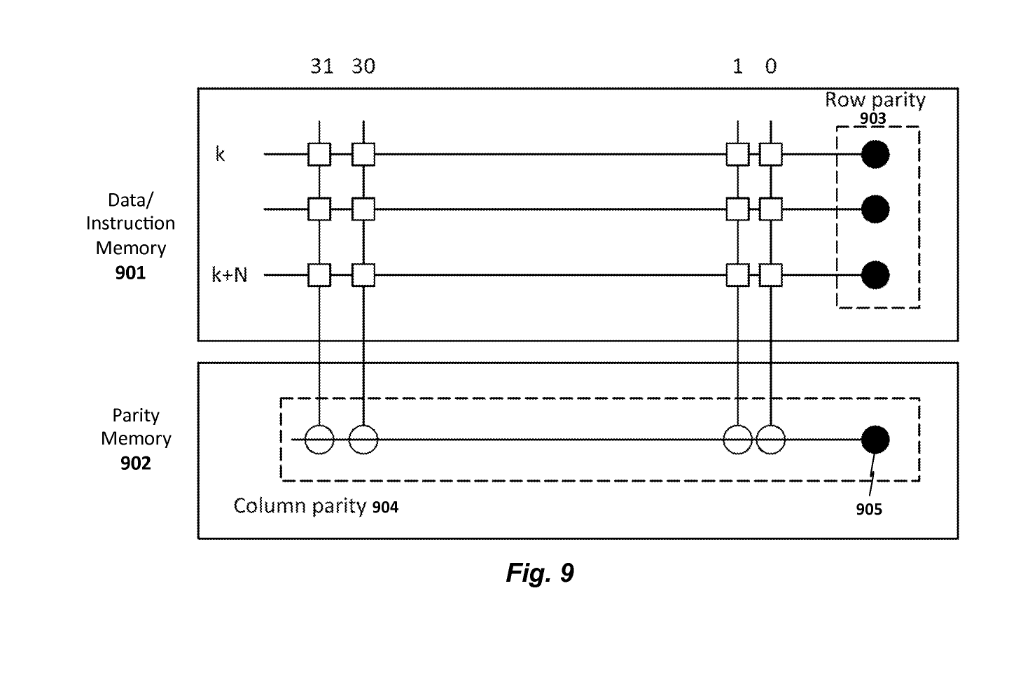

As illustrated in FIG. 9, one embodiment of the invention includes a data/instruction memory 901 for storing data or instructions in 32 bit rows, and a row parity data 903 comprising a parity value for each row. In addition, the illustrated embodiment includes a parity memory 902 for storing column parity data 904 comprising a parity value associated with each column of data in the data memory. While illustrated as separate memories in FIG. 9, in one embodiment, the data/instruction memory 901 and parity memory 902 may implemented within a single physical memory. Moreover, while FIG. 9 only shows one block of memory, for a real use case many such blocks may be combined to form the data/instruction and the parity memory.

In one embodiment, the row parity 903 is calculated and stored for the entire data bits of one word (32 bits). Additionally, a number (N) of words are formed as a “block” and then a column parity bit is generated along each “column.” All column parity bits 904 form a parity word associated with this block. Additionally, in one embodiment, the parity word 904 is protected by one row parity bit 905.

In one embodiment, the ECC logic 811 performs error detection using the row parity 903 whenever a data word is read. This parity checking may be implemented as a simple XOR tree. If there is no parity error, the data word can be presented to the functional unit/core in the next clock cycle. If there is a row parity error, then the column parity 904 over N data words belonging to this group are first checked. Assuming the single error model, exactly one column parity error will show up. With the row number of the detected row parity error and column number of the detected column parity error, the error correction circuitry 811 may correct the single bit error before delivering the data word to the functional unit/core (or other consumer type).

If there is no column parity error although there is a row parity error, or more than one column parity errors show up, then the single bit error model assumption is not valid. One embodiment of the invention can detect this situation but does not include circuitry for correcting the error. Rather, in one embodiment, a crash signal is sent to higher level system components. Note that this holds also for the standard ECC scheme with 6 bits overhead for 32 bit data.

In addition, one embodiment of the invention performs a row parity check over the parity word containing all column parity bits. For example, the column parity data may be checked by the row parity bit 905 mentioned above.

The above scheme reduces the overhead of the standard ECC scheme significantly at the cost some of additional glue logic and additional time necessary to correct the error. Considering the fact that memory leakage grows significantly in current process technology (e.g., 14 nm), this trade-off justifies the additional glue logic consisting in one embodiment of XOR trees, multiplexers and simple finite state machines.

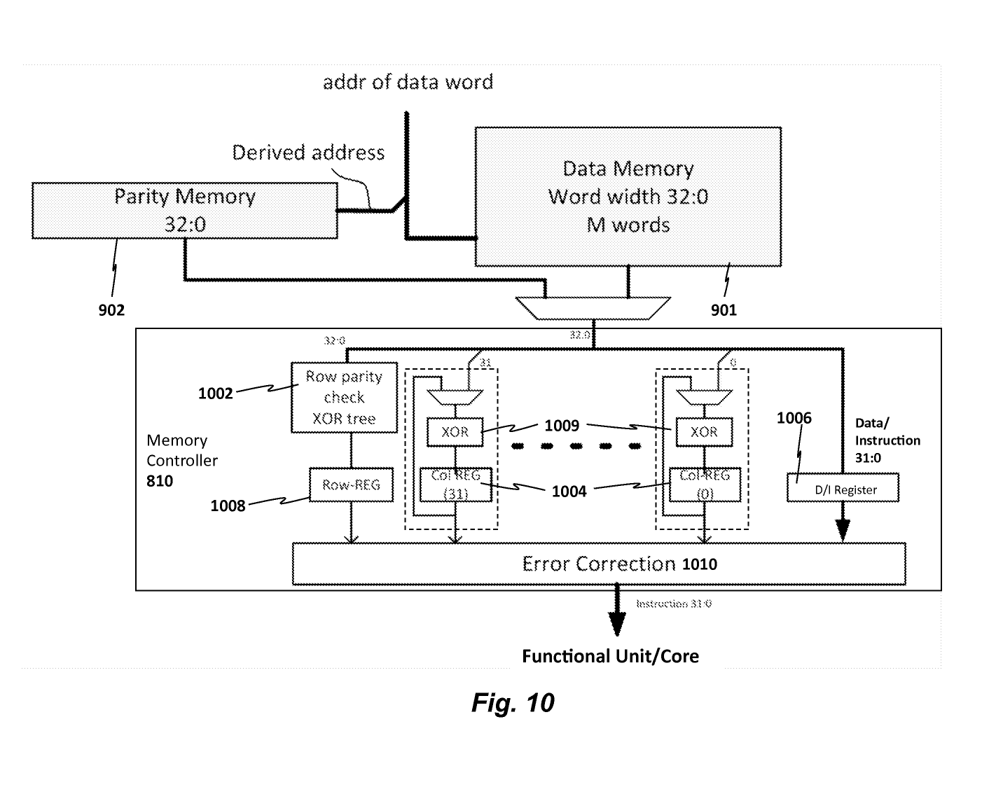

FIG. 10 provides additional details of one embodiment of the invention. For any read from the protected memory, the row parity error check is performed using row parity check XOR tree 1002 and the result stored in a row register 1008 (e.g., indicating the row in which there is a parity error, if any). If the row parity check is error free, then the data or instruction word is sent to the requesting functional unit/core from a data/instruction register 1006. In one embodiment, the control is provided via error correction logic 1010 which determines that no error is present and forwards the data/instruction.

In one embodiment, if a row parity error is detected, then the functional unit/core may be halted (e.g., using a busy signal, stopping the clock, etc). The block in memory is looped over to read out N data words, the parity of each of the N words is checked and the errors are counted. Additionally, the parity word of this block is read from the parity memory. In one embodiment, the parity of bit i is accumulated in each of 32 registers Col-REG(i) 1004. The accumulated XOR registers 1009 should show one single error bit set at the corresponding bit position based on single error model. If there is no error shown, then the single error model for this memory is not valid (e.g., a double error may have happened). That is, if there is one row parity error then the single-bit error happened in the row parity bit itself and can be corrected. If the number of row parity errors is greater than 1, in one embodiment, the error correction logic 1010 will signal that a crash has been detected to the higher layers for recovery.

If an error is shown in the accumulated XOR registers 1009, then the error correction logic 1010 checks the correctness of the column parity word in the memory (as mentioned, the parity word may be protected by a single parity bit 905). If an error is detected, then the error correction logic 1010 will signal that a crash has been detected to the higher layers for recovery as the column index cannot be determined using the erroneous parity word.

If an error is not detected in the parity word, then the error correction logic 1010 corrects the data/instruction the data/instruction register 1006 at the bit position <i> indicated by the XOR register(i) 1009 set equal to 1. In one embodiment, the corrected data/instruction word is then written back into memory. The functional unit/core is released from halt and delivers the corrected instruction word to the core.

In terms of processing latency, with the detection of a row parity error, the functional unit/core is halted until the error correction is completed. A straightforward scheme would require about N clock cycles to iterate over N words of the block. An improved scheme is to compute the parity error continuously by accumulating the result as shown in FIG. 10. If the row parity error happens at word k mod N=0, then the correction latency represents the worst case with N clock cycles. If the row parity error happens for word k mod N=N−1, then this results in one cycle of latency.

In general, the latency would then be about N−(k mod N) depending on the position of the data word or instruction word within the block. To implement this scheme, additional circuitry may be used to compare two consecutive addresses to detect a jump (i.e., no linear addressing). In the case of a jump, the accumulator is reset.

One embodiment applies a scheme for single error detection and correction which requires:
4 check bits per 8 bit data (i.e., 12 bits total) or 50% overhead;
5 check bits per 16 bit data (i.e., 21 bits total) or 31% overhead; or
6 check bits per 32 bit data (i.e., 38 bits total) or 19% overhead.

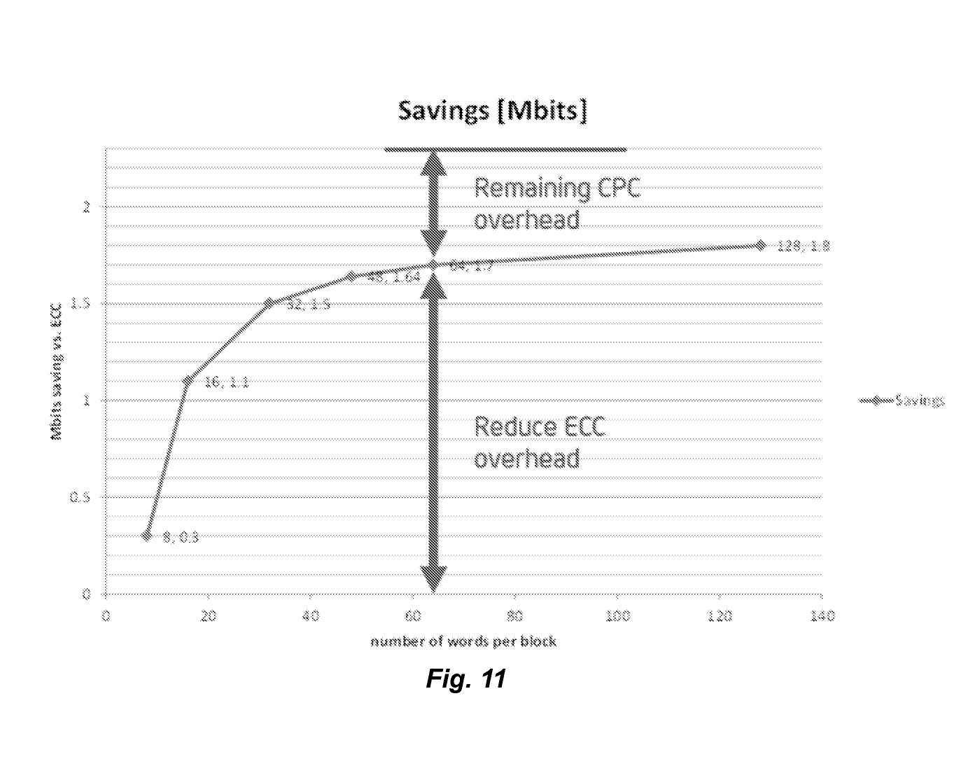

Depending on the chosen parameters, namely data bit width and N for the number of words per block, the overhead can be reduced significantly, especially for a 32-bit processor (where 32 bits represents the bit width of interest). FIG. 11 shows the absolute savings for an example with a data memory of 1600 kBytes. For N=64, the reduction of 1.7 Mbits is equivalent to 74% of the original overhead (2.3 Mbits) as only 0.6 Mbits have to be added. The implementation can choose N according to the latency which can be tolerated by the system.

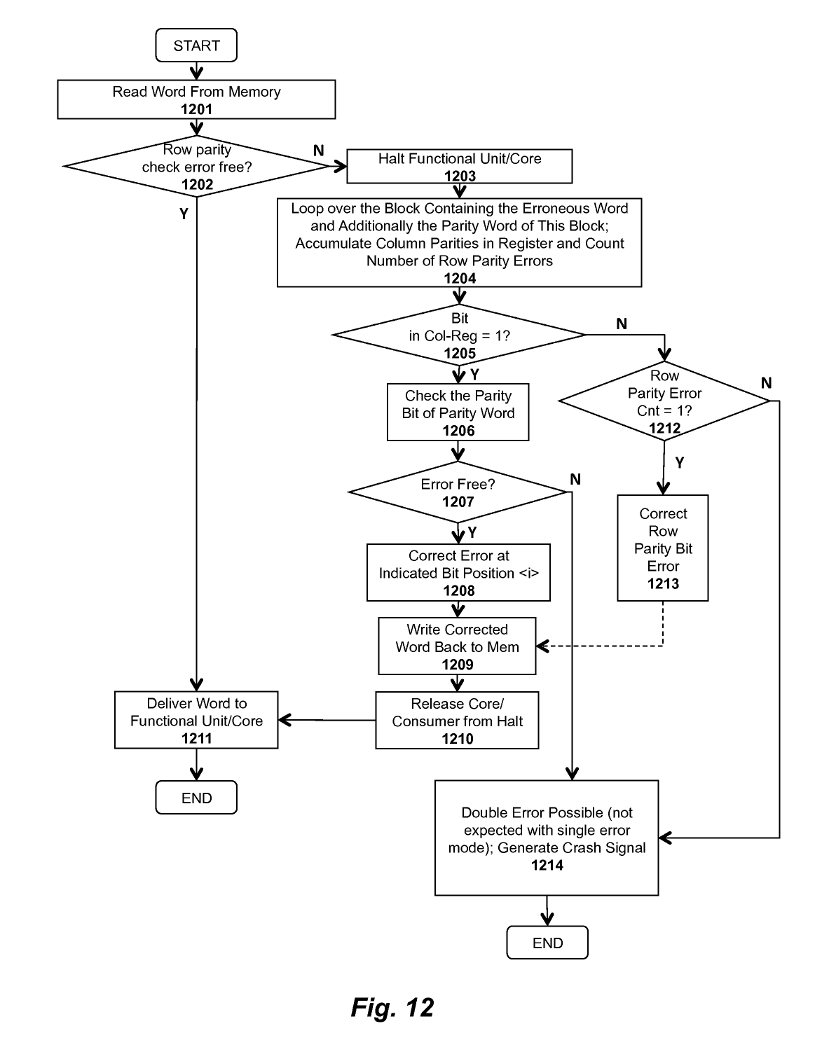

A method in accordance with one embodiment of the invention is illustrated in FIG. 12. The method may be implemented within the architectures shown in FIGS. 9-10, but is not limited to any particular architecture.

A word is read from memory at 1201 (e.g., an instruction or data word) and a determination is made at 1202 as to whether row parity indicates that there are errors. If not, then the word is delivered to the functional unit/core at 1211. If so, then at 1203, the functional unit, core, or other type of consumer is halted. At 1204, a loop is performed over the block containing the erroneous word and the parity word for the block, each row parity is checked and the errors are counted. Column parities are also accumulated. At 1205 a determination is made as to whether any bit in a column-register is set equal to 1 (indicating an error in the corresponding column). If not, then at 1212, the number of counted row parity errors is checked. If it is exactly 1 then the single-bit error happened in the row parity bit and can be corrected at 1213, otherwise a double bit error is possible and a crash signal is generated at 1214. If the determination at 1205 is that that a bit in a column-register is set equal to 1, then at 1206 the parity bit of the parity word is checked. If it is not error free, then the process returns to 1214 and a crash signal is generated. If it is error free, then at 1208, the error correction logic corrects the error indicated at bit position <i>. The corrected word is written back to memory at 1209 and the functional unit/core is released from halt at 1210.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

For example, although referred to herein as “column parity,” embodiments of the invention may compute the column parity bit differently than described above. For example, the column parity bit <i> could also be computed from taking bit <i> at row 0, bit <i+1> from row 1, etc, with a wrap-around if <i+k> is larger than N−1 (where N is the word width). This technique creates more effort on the part of the error checking logic. But, significantly, the embodiments of the invention are not restricted to computing the column parity bit <i> from taking bit <i> of all rows.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the Figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals—such as carrier waves, infrared signals, digital signals, etc.).

In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware. Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

What is claimed is:

1. An electronic circuit comprising:
one or more memories to store data or instructions in rows and columns, and to further store row parity data comprising a parity value associated with each row and column parity data comprising a parity value associated with each column; and
error checking logic to perform a row parity check to detect if errors exist in any of the rows, wherein if an error is detected in one of the rows, the error checking and correction logic is to perform a column parity check to identify a column in which the detected error occurred; and
error correction logic to correct the detected error using the detected row and column identified by the error checking logic.

2. The electronic circuit as in claim 1 further comprising:
a functional unit or core to receive the data or instruction without error correction if no error is detected in any of the rows, or with correction if the error is corrected by the error correction logic.

3. The electronic circuit as in claim 1 wherein the one or more memories comprises a data or instruction memory to store the rows and columns of data/instructions and to further store the parity values associated with each row.

4. The electronic circuit as in claim 3 wherein the one or more memories comprises a parity memory to store the column parity data comprising the column parity values associated with each column.

5. The electronic circuit as in claim 1 wherein the one or more memories are to further store a parity value usable by the error checking logic to detect errors in the column parity data.

6. The electronic circuit as in claim 5 wherein the electronic circuit is to generate a crash signal or other exception if an error is detected in the column parity data or if an error is detected in one of the rows but not in one of the columns.

7. The electronic circuit as in claim 1 wherein the error checking logic comprises an XOR tree to perform a row parity check to detect if errors exist in any of the rows.

8. The electronic circuit as in claim 1 wherein the error checking logic comprises a plurality of column registers to store a parity bit for each column.

9. The electronic circuit as in claim 8 wherein the error checking logic further comprises a plurality of accumulated XOR registers, one for each column, wherein the XOR registers are to indicate a bit error associated with a corresponding column.

10. The electronic circuit as in claim 1 further comprising a data/instruction register to store current data or a current instruction for which error detection and correction are to be performed.

11. A method comprising:
storing data or instructions in rows and columns within one or more memories;
storing row parity data comprising a parity value associated with each row and column parity data comprising a parity value associated with each column;
performing a row parity check to detect if errors exist in any of the rows, wherein if an error is detected in one of the rows then performing a column parity check to identify a column in which the detected error occurred; and
correcting the detected error using the detected row and column identified by the error checking logic.

12. The method as in claim 11 further comprising transmitting the data or instruction to a functional unit or core without error correction if no error is detected in any of the rows, or with correction if the error is corrected by the error correction logic.

13. The method as in claim 11 wherein the one or more memories comprises a data or instruction memory to store the rows and columns of data/instructions and to further store the parity values associated with each row.

14. The method as in claim 13 wherein the one or more memories comprises a parity memory to store the column parity data comprising the column parity values associated with each column.

15. The method as in claim 11 wherein the one or more memories are to further store a parity value usable by the error checking logic to detect errors in the column parity data.

16. The method as in claim 15 further comprising generating a crash signal or other exception if an error is detected in the column parity data or if an error is detected in one of the rows but not in one of the columns.

17. The method as in claim 11 further comprising using an XOR tree to perform a row parity check to detect if errors exist in any of the rows.

18. The method as in claim 11 further comprising storing a parity bit for each column in a plurality of column registers.

19. The method as in claim 18 further comprising providing a plurality of accumulated XOR registers, one for each column, wherein the XOR registers are to indicate a bit error associated with a corresponding column.

20. The method as in claim 11 further comprising store current data or a current instruction for which error detection and correction are to be performed in a data/instruction register.

21. A system comprising:
a system memory to store instructions and data;
a plurality of functional units or cores to execute the instructions and process the data;
a graphics processor to perform graphics operations in response to certain instructions;
a network interface for receiving and transmitting data over a network;
an interface for receiving user input from a mouse or cursor control device; and
an electronic circuit comprising:
one or more internal processor memories to store data or instructions in rows and columns, and to further store row parity data comprising a parity value associated with each row and column parity data comprising a parity value associated with each column; and
error checking logic to perform a row parity check to detect if errors exist in any of the rows, wherein if an error is detected in one of the rows, the error checking and correction logic is to perform a column parity check to identify a column in which the detected error occurred; and
error correction logic to correct the detected error using the detected row and column identified by the error checking logic.

22. The system as in claim 21 wherein a functional unit or core is to receive the data or instruction without error correction if no error is detected in any of the rows, or with correction if the error is corrected by the error correction logic.

23. The system as in claim 21 wherein the one or more internal processor memories comprises a data or instruction memory to store the rows and columns of data/instructions and to further store the parity values associated with each row.

24. The system as in claim 23 wherein the one or more internal processor memories comprises a parity memory to store the column parity data comprising the column parity values associated with each column.

25. The system as in claim 21 wherein the one or more internal processor memories are to further store a parity value usable by the error checking logic to detect errors in the column parity data.
